(19) United States
(12) Patent Application Publication
(10) Pub. No.: US 2003/0218636 A1
(43) Pub. Date: Nov. 27, 2003

(54) Dynamic display management

(76) Inventors: C. Kevin McIntyre, Boise, ID (US); Joe F. Goicoechea, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/152,699

(22) Filed: May 22, 2002

(51) Int. Cl. G09G 5/00

(52) U.S. Cl. 345/809; 345/796

(57) ABSTRACT

The invention enables a computer user to customize the display of dialog boxes within a graphical user interface of a windowed operating system. More particularly described, some embodiments of the present invention enable a computer user to specify preferred and/or frequently used pages to be displayed as the top page of a dialog box when the dialog box is launched. In the illustrative embodiments presented herein, the invention is described in relation to managing the display of dialog boxes associated with device drivers, such as printer drivers. It is to be understood, however, that the present invention is not limited to printer driver dialog boxes but, rather, can be applied to any dialog box or other graphical user interface element having multiple pages and/or views.

### FIELD OF THE INVENTION

The present invention relates generally to the field of computer user interfaces. More particularly, the present invention relates to the dynamic display, control, and management of dialog boxes in a graphical user interface of a computer.

### BACKGROUND OF THE INVENTION

A graphical user interface (“GUI”) is a typical means for presenting information to users of computer systems. A graphical user interface conventionally is a part of a computing environment provided by an operating system executed by a processor of a computer system. The graphical user interface is generally controlled by the operating system in response to commands provided by a user and application programs or other processes executing on or accessible to the computer system. Exemplary operating systems providing graphical user interfaces are the several WINDOWS® operating systems manufactured by Microsoft, Inc.

The use of a mouse, trackball, or other pointing device in a windowed computing environment is common to virtually all conventional graphical user interfaces. Windows are rectangular areas presented on a display that contain textual and/or graphical information concerning the operation of an application program, operating system, device driver, or other processes. In general, additional display elements are provided by the graphical user interface to facilitate interaction with the computer system. Exemplary additional display elements include, but are not limited to, menus, title bars, buttons, select boxes, and icons.

In a windowed computing environment, the user interacts with the computer by using the keyboard and/or by manipulating the cursor displayed on the graphical user interface with a pointing device, such as a mouse or trackball. As used herein, “pointing device,” means any device that enables a user to control the movement of the cursor or pointer within a graphical user interface. Pointing devices conventionally have at least one button, which is conventionally clicked to perform various functions, such as selecting an object. To enter information into the computer system or to select certain functions, a user typically interacts with a displayed window in one way or another. In certain circumstances, a “dialog box” is displayed on the graphical user interface to enable the user to enter specific information or selections of functions into the computer system. Dialog boxes are special windows presented on the graphical user interface to facilitate providing inputs to the computer to control application programs, device drivers, or other processes occurring within or accessible to the computer system. Dialog boxes generally present logically related control input display elements, such as fields for numeric or text entry, icons, select boxes, buttons, and a myriad of other known display elements that enable a user to set parameters or otherwise effect control of the desired process or system.

A dialog box typically appears as a result of selecting a command from a menu comprising a list of available commands. The dialog box can make additional selections available to the user or it can display additional information. In this way, the dialog box can serve in the manner of an extension of the individual commands available in the menu. The dialog box can display these additional choices in the form of radio buttons, push buttons, list boxes, drop-down list boxes, check boxes, option buttons, and text buttons, among others. Dialog boxes are commonly known as child windows that are typically owned by a program's main window.

While dialog boxes typically simplify the presentation of information to a user, it is frequently necessary for a user to navigate through a series of cascading dialog boxes to set a value or input information. If the user improperly sets a previous value or forgets a key piece of information, it would in the past be necessary to close the series of dialog boxes and begin again. The introduction of tabbed dialog boxes (also referred to as property sheets) improved and simplified the display of dialog boxes. Tabbed dialog boxes conventionally compile sets of logically related dialog boxes into a single display element. A tabbed dialog box conventionally comprises a frame, title bar, and push buttons (e.g., OK, Cancel, Apply, and Help). Each of the pages of a tabbed dialog box conventionally controls its own control windows (e.g., buttons, check boxes, and the like) and has a single tab associated and displayed therewith. Hence, each tab is displayed in association with only one dialog box such that the user selection of the tab can move and display only a single associated dialog box.

Among the disadvantages of prior art tabbed dialog boxes is the fact that a user is required to navigate through the tabbed dialog box in order to locate the particular tabbed dialog box page in which he or she needs to work. In some circumstances, such navigation further entails navigating through a set of pages within a tabbed dialog box page. This situation is particularly cumbersome and frustrating because many users find the process of navigating through the tabbed dialog box to be difficult, time-consuming, and/or unintuitive.

While tabbed dialog boxes have considerably simplified the display of dialog boxes, there continues to be a need in the art for more efficient and flexible means for displaying dialog boxes. In particular, it would be advantageous to provide methods, systems, apparatuses, and computer program products that enable a user to customize the display of dialog boxes such that preferred and/or frequently used pages may be designated by a user to be presented as the default, or top, page when a tabbed dialog box is launched, thereby providing the user with greater efficiency and ease of use of tabbed dialog boxes. The present invention includes methods, systems, apparatuses, and computer program products that realize the foregoing advantages.

### BRIEF SUMMARY OF THE INVENTION

The present invention may be used with either modal or modeless dialog boxes. In one embodiment of the present invention, a computer user is enabled to customize the display of dialog boxes within a graphical user interface of a windowed operating system. More particularly, the embodiments of the present invention enable a computer user to specify preferred and/or frequently used pages to be presented as the default, or top, page of a dialog box when the dialog box is launched. As used herein, “top page” means the page of a dialog box that is displayed first when the dialog box is launched. In some embodiments of the present invention relate to managing the display of dialog boxes associated with device drivers, such as printer drivers.

In yet other embodiments of the invention, a computer program product for use with a computer system having an operating system is disclosed. The computer program product comprises a computer usable medium having embodied therein computer readable program code method steps for managing a graphical user interface in the computer system in response to a receipt of an activation request to open a selected dialog box.

For purposes of illustration only, the present invention will be described, as it would be embodied in a printer driver dialog box. It will be appreciated that the invention can be useful in a variety of applications in graphical user interfaces.

In the case of a printer driver including the present invention, the general construction of the driver is modified to allow the user to set a default, or top, page to be displayed as the first displayed page when the printer driver is invoked. A radio button or the like (“selection element”) is included on each page of the printer driver dialog box, which allows the user to designate any given page as the top page for display when the dialog box is launched. Such a selection element may be labeled “Display as Top Page” or the like. The user can disable a previous top page designation by clicking again on (reselecting) the selection element on the previously designated page. When the user has already designated a first page as the top page and later designates a second page as the top page, the printer driver dialog box automatically unselects the first page when the second page is designated. In this way, only one page is designated as the top page at any given time. If no top page has been set, the manufacturer's standard layout of the driver is used.

The present invention, as well as the structure and operation of various embodiments of the present invention, are described in detail below with reference to the accompanying drawings. In the drawings, like reference numerals indicate identical or functionally similar elements.

### BRIEF DESCRIPTION OF THE DRAWINGS

The present invention can be more readily ascertained from the following description of the invention when read in conjunction with the accompanying drawings in which:

FIG. 1 is a functional block diagram of an exemplary computer system suitable for implementing the present invention;

FIG. 2 is a software layer diagram of one embodiment of the present invention as implemented with a conventional operating system;

FIG. 3 is a screen of exemplary printer driver dialog box using the present invention;

FIG. 4 is a screen of printer driver dialog box according to the present invention;

FIG. 5 is a screen of printer driver dialog box in operation according to the present invention;

FIG. 6A is a screen of printer driver dialog box in operation according to the present invention further to the situation depicted in FIG. 5;

FIG. 6B is a screen of printer driver dialog box according to the present invention in operation further to the situation depicted in FIG. 5;

FIG. 6C is a screen of printer driver dialog box in operation according to the present invention further to the situation depicted in FIG. 5;

FIG. 7 is a functional block diagram of one embodiment of the dialog box control system of the present invention;

FIG. 8 is a functional block diagram of one embodiment of the dialogs 704 implemented in the dialog box control system of the present invention;

FIG. 9 is a block diagram of one embodiment of the method of the present invention; and

FIG. 10 is an illustration of that portion of the method of FIG. 9 in which a dialog box control system processes a user designation of a page of the dialog box as the top page.

### DETAILED DESCRIPTION OF THE INVENTION

The present invention may be used with either modal or modeless dialog boxes. The invention enables a computer user to customize the display of dialog boxes within a graphical user interface of a windowed operating system. More particularly, embodiments of the present invention enable a computer user to specify preferred and/or frequently used pages to be displayed as the top page of a dialog box when the dialog box is launched. In various embodiments of the present invention, the invention is described and illustrated in relation to managing the display of dialog boxes associated with device drivers, such as printer drivers. It is to be understood, however, that the present invention is not limited to printer driver dialog boxes but, rather, can be applied to any dialog box or other graphical user interface element having multiple pages and/or views.

In one embodiment of the invention, a computer program product for use with a computer system having an operating system is disclosed. The computer program product comprises a computer usable medium having embodied therein computer readable program code method steps for managing a graphical user interface in the computer system in response to a receipt of an activation request to open a selected dialog box.

In another embodiment of the invention, a computer system is disclosed. The computer system includes an operating system responsive to one or more system calls, each causing the operating system to process user inputs in a predetermined manner. Also included in the computer system is a graphical user interface configured to generate one or more dialog box control requests in response to user inputs provided on the graphical user interface and a plurality of dialogs, each constructed and arranged to control display of and interactivity with an associated dialog box open on the graphical user interface in response to one or more of the dialog box control requests.

A dialog box control system, operatively interposed between the graphical user interface and the operating system, is responsive to a selected one of a plurality of dialog launch display configurations. The dialog box control system may be constructed and arranged to display the pages of the dialog box in a predetermined order or, under certain circumstances, to display a designated page of the dialog box as the top page of the dialog box.

For purposes of illustration only, the present invention will be described as embodied in a printer driver dialog box. It will be appreciated that the present invention can be useful in a variety of applications in the field of operating systems and graphical user interfaces.

In the example of a printer driver, the general construction of the driver dialog box is modified to allow the user to designate any given page of the dialog box as the top page. A radio button or the like (“selection element”) is included on each page of the printer driver dialog box, which allows the user to designate any given page as the top page for display by selecting the selection element on the page to be so designated. The selection element preferably may be labeled “Display as Top Page” or the like. The user can disable the top page designation by clicking again on (reselecting) the selection element on the subject page. When the user has already designated a first page as the top page and later designates a second page as the top page, the printer driver dialog box automatically unselects the first page when the second page is designated. In this way, only one page is designated as the top page at any given time. If no top page has been set, the standard layout of the driver is used.

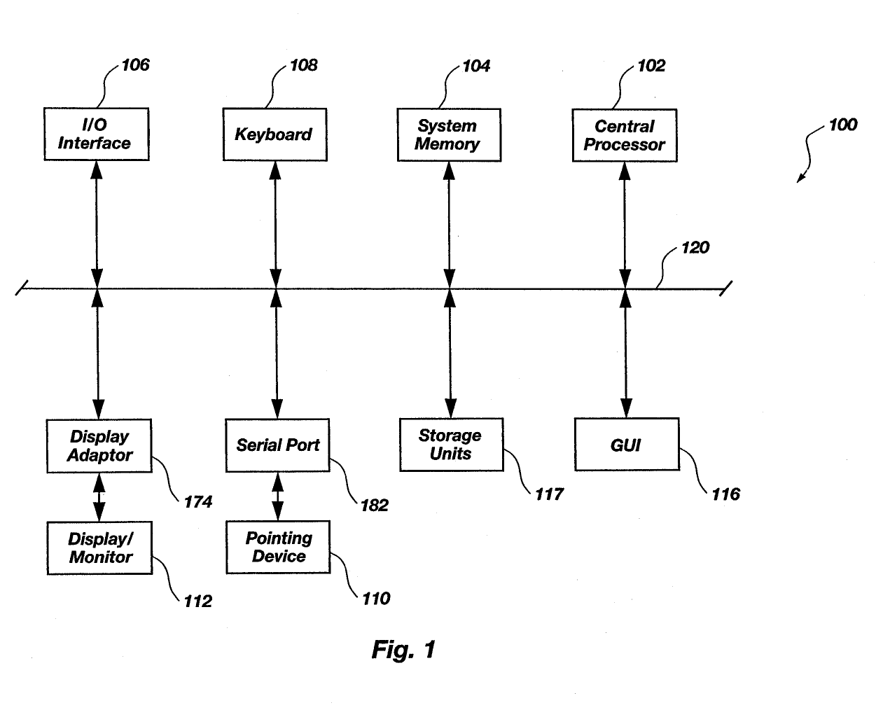

Drawing FIG. 1 illustrates a block diagram of a computer-based system suitable for implementing the present invention. Computer system 100, which is but one example of many possible computer system configurations capable of being used with the present invention, is illustrated. Computer system 100 is preferably a general-purpose computer system that is programmable using a high-level computer programming language.

Computer system 100 includes a number of basic subsystems represented by blocks for ease of illustration. Computer system 100 includes a central processor 102, a system memory 104, input/output interface cards 106, storage units 117, such as a hard disk drive and/or a floppy disk drive, one or more input devices, such as keyboard 108 and pointing devices 110, and display 112. System memory 104 is used for storage of program instructions and for storage of results of calculations performed by the central processor 102. In some embodiments, system memory 104 includes random access memory (RAM). Display 112 is logically or physically divided into an array of picture elements referred to as pixels. The input/output interface cards 106 may be modem cards, network interface cards, sound cards, etc. Additional subsystems such as a display adaptor 174 and serial port 182 also are shown. Other subsystems may be added to computer system 100, as necessary or appropriate.

The central processor 102 is typically a commercially available processor such as the PENTIUM® processor, POWERPC® processor, SPARC® processor, PA-RISC® processor or a 68000 series microprocessor. Many other processors are also available. Such a processor usually executes a program referred to as an operating system 114 such as the various versions of the WINDOWS® operating systems from Microsoft Corporation, the NETWARE® operating system available from Novell, Inc., or the UNIX operating system available from many vendors such as Hewlett-Packard Company, Palo Alto, Calif., and Sun Microsystems, Inc. Operating system 114 controls the execution of other computer programs such as a graphical user interface (GUI) 116 and the dialog box control system 118 and provides scheduling, input/output control, file and data management, memory management and related services.

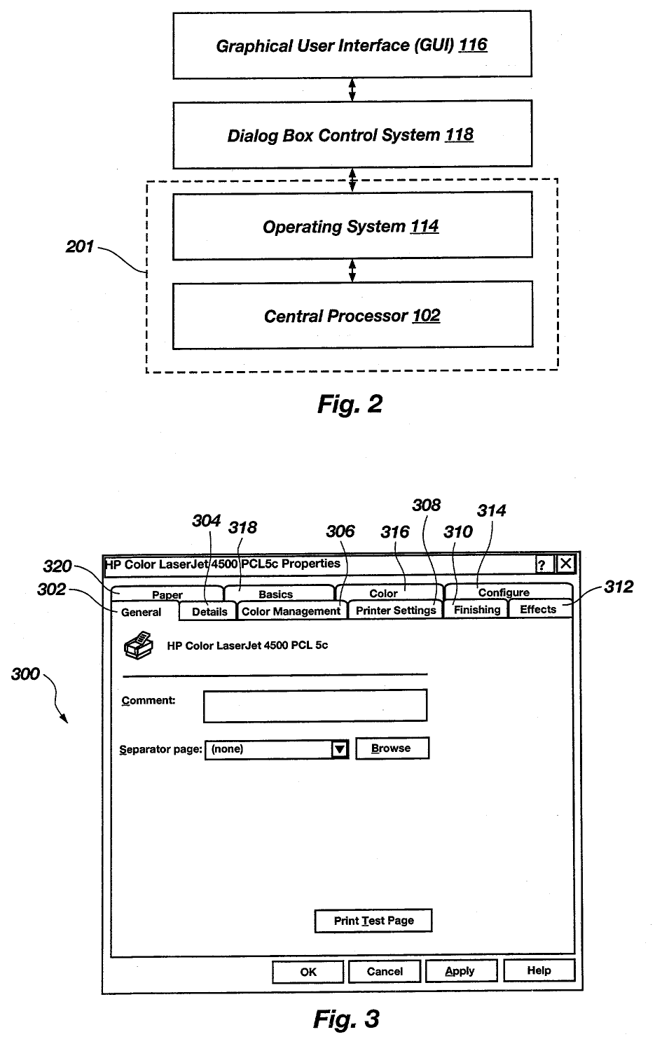

Referring now to drawing FIGS. 1 and 2, central processor 102 and operating system 114 define a computer platform shown by dashed block 201, for which application programs and high-level programming languages are written. The functional elements of computer system 100 communicate with each other via one or more buses 120. The interconnection via system bus 120 allows central processor 102 to communicate with each subsystem to control the execution of instructions from system memory 104 and to exchange information between subsystems. The storage unit 117 may include disk drives, magnetic media, optical media, solid-state memory, bubble memory, etc. Other configurations of subsystems and interconnections are possible, all of which, whether known now or in the future, are within the spirit and scope of the present invention.

The present invention provides an efficient and user-friendly way to manage the display of dialog boxes in a graphical user interface 116. The dialog box control system 118 of the present invention provides a plurality of dialog box display management functions. The dialog box display management functions control the display of dialog boxes such that only dialog box pages predetermined to be the top page are presented as the first-to-appear page when the dialog box is launched. It is appreciated that any page may be presented as the first to appear page when the dialog box is launched.

In one embodiment of the present invention, the dialog box control system 118 is implemented in software routines, which interoperate with the components of the implementing computer-based system to perform the dialog box management functions in accordance with the present invention. Such software routines typically reside in memory 104 and/or storage units 117, and may be stored on any other computer-readable medium such as, for example, magnetic disk, compact disc, or magnetic tape, and may be loaded into the computer system 100 using an appropriate peripheral device as known in the art. Preferably, this embodiment of the dialog box control system 118 is implemented in a well-known object-oriented programming language such as JAVA or C++. Those skilled in the art will appreciate that different implementations, including different function names, programming languages, data structures, and/or algorithms may also be used in embodiments of the present invention other than those described below. It should be further understood that the invention is not limited to a particular computer platform, a particular operating system, a particular processor, or a particular programming language, and that the hardware components identified above are given by way of example only. The dialog box control system 118 may be implemented, for example, in dedicated hardware, embedded software (firmware), or any combination thereof.

Before describing the functions and operations of the present invention, some initial concepts are provided. A typical graphical user interface will be described, including the manner in which dialog boxes can be launched in such a typical environment. Then, the manner in which the display of dialog boxes is managed by the present invention is described.

As used herein, the term “dialog box” refers to any interactive window that is displayed on a computer user interface, such as graphical user interface 116, to receive control inputs through an input/output device. In general, dialog boxes are special interactive windows that present logically related control input display elements that enable a user to set parameters or otherwise effect system control, including, for example, icons, select boxes, text and numeric fields, scroll bars, and others. Dialog boxes are generally presented on the graphical user interface to enable a user to input information and make selections, thereby facilitating control of the operating system, application programs, or other processes occurring within or accessible to the implementing computer-based system. The control inputs may be in any form, such as selection of an icon, select box, radio button or other display element, or entry of numeric, alphabetic or alphanumeric information into an entry field. Numerous other techniques, now or later developed, may be used with the present invention to display and enter information into a dialog box on a computer user interface, all of which are considered to be within the spirit and scope of the appended claims.

In a typical environment described herein, dialog boxes may be displayed as follows. Displayed dialog boxes are those dialog boxes that are launched through the user's selection of a dialog launch display element on the graphical user interface 116 or through other means external to the present invention, such as in response to the occurrence of an event in a process monitored by the implementing computer system. The user may selectively close a dialog box by selecting an appropriate icon, button, field or menu item. Closing a dialog box in this manner (herein referred to as “selectively closing”) indicates that the control inputs entered into the dialog box are to be applied to the implementing computer-based system. Commonly, such an appropriate selection is the selection of an “OK” or “Enter” button presented on the dialog box. Alternatively, the dialog box may be closed non-selectively, typically by selecting a “Cancel” or “Exit” button or an analogous button, selection box or icon provided on the dialog box, in which case no control inputs are applied to the implementing computer system.

Dialog boxes are launched or invoked in response to the selection of what is referred to herein as a “dialog launch display element”. A dialog launch display element may be a menu item or icon on a main window display, or a display element presented on a dialog box, such as an icon, button or menu item. In many cases, a dialog launch display element includes a text description followed by an ellipsis, such as “print . . . ” or “save as. . .” in a pull-down menu or on an icon, identifying the subject matter of the dialog box that would be invoked by selecting that menu item, button, or icon.

For each dialog box, there may be one or more dialog launch display elements rendered at different locations and at different times on the graphical user interface 116. For example, a dialog box may be launched from a dialog launch display element on the main menu as well as from a dialog launch display element on another dialog box. It should be understood that any other technique or method now or later developed for invoking or launching a dialog box is considered to be within the scope of the present invention. This includes internally generated events, other user selection techniques, and so on. Each dialog box is assigned an identifier accessible to the graphical user interface 116. In accordance with the present invention, when a dialog box is selected, the graphical user interface 116 obtains the identifier for the selected dialog box as well as the ID of the dialog box (if any) on which the launch display element selected by the user is located. These identifiers are provided to the dialog box control system 118 by the graphical user interface 116 in accordance with the present invention. In one embodiment, the identifiers are integers, although any numbers of values of any format or type may be used depending upon the application of the present invention.

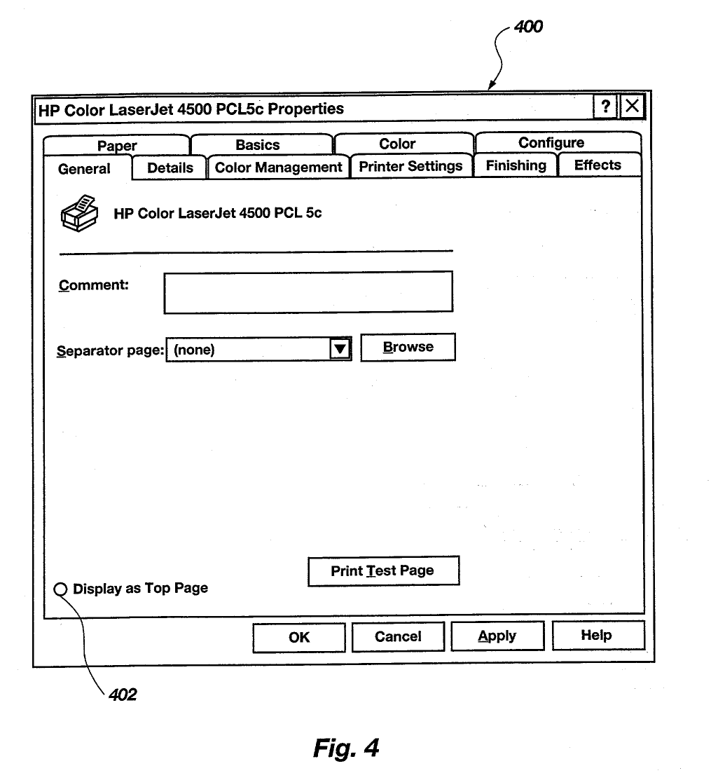

Dialog boxes typically have a standard display layout. The standard display layout is the layout specified by the creator of the dialog box, without any changes made by a user. A screen shot of an exemplary printer driver dialog box 300 is provided in drawing FIG. 3. Exemplary printer driver dialog box 300 is displayed in standard layout, meaning that the user has not made any changes to the order in which the several pages, or tabs, of the dialog box are displayed. Displayed within prior art printer driver dialog box 300 are “General” page 302, “Details” page 304, “Color Management” page 306, “Printer Settings” page 308, “Finishing” page 310, “Effects” page 312, “Configure” page 314, “Color” page 316, “Basics” page 318, and “Paper” page 320, with “General” page 302 being the standard top page. In this condition, “General” page 302 is displayed as the top page each time exemplary printer driver dialog box 300 is launched.

As discussed above, a user may determine that the standard layout is not ideal from the perspective of that user's regular interactions with the dialog box. For instance, the user may need to work with “Paper” page 320 more frequently than other pages within the dialog box. In such a case, it would be advantageous for the user to be able to designate “Paper” page 320 as the top page to be displayed when the dialog box is launched. In this way, the user would not be required to navigate through the dialog box to find his or her preferred page, thus providing the user with greater efficiency and ease of operation of the dialog box.

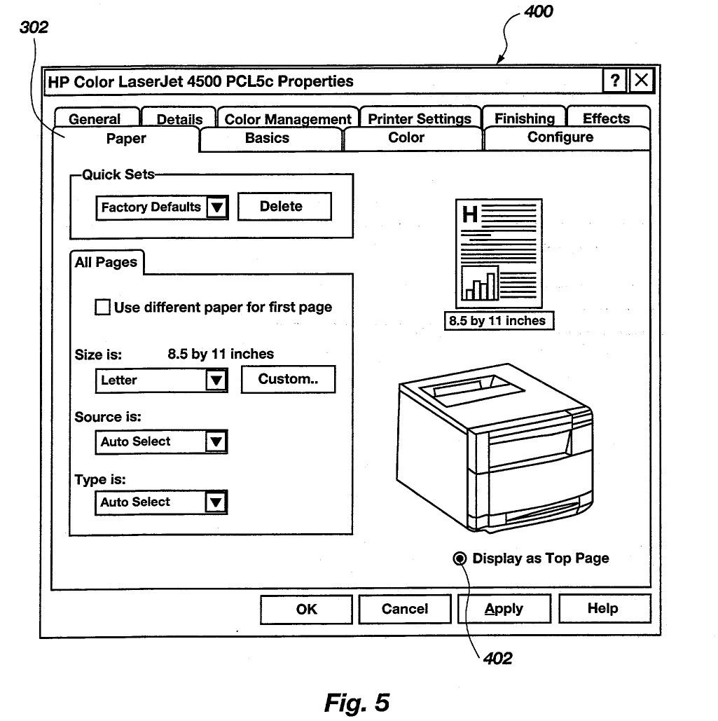

Accordingly, the present invention enables the user to designate which of the pages of a tabbed dialog box will be displayed as the top page when the dialog box is launched. Drawing FIG. 4 illustrates printer driver dialog box 400 according to the present invention in which the user has not altered the standard layout of the dialog box. Printer driver dialog box 400 differs from exemplary printer driver dialog box 300 in that it includes a selection element 402 with the title “Display as Top Page”. As illustrated in drawing FIG. 4, selection element 402 has not been selected, so the standard layout of the dialog box remains unchanged. Each of the pages of dialog box 400 has a selection element 402 with the title “Display as Top Page”, enabling a user to designate any one of the pages to be displayed as the top page when printer driver dialog box 400 is launched. As illustrated in drawing FIG. 4, selection element 402 is depicted as a radio button. In addition to using radio buttons, any other type of selection element, such as selection boxes, may be used. Also, any appropriate descriptive title other then “Display as Top Page” may be associated with selection element 402.

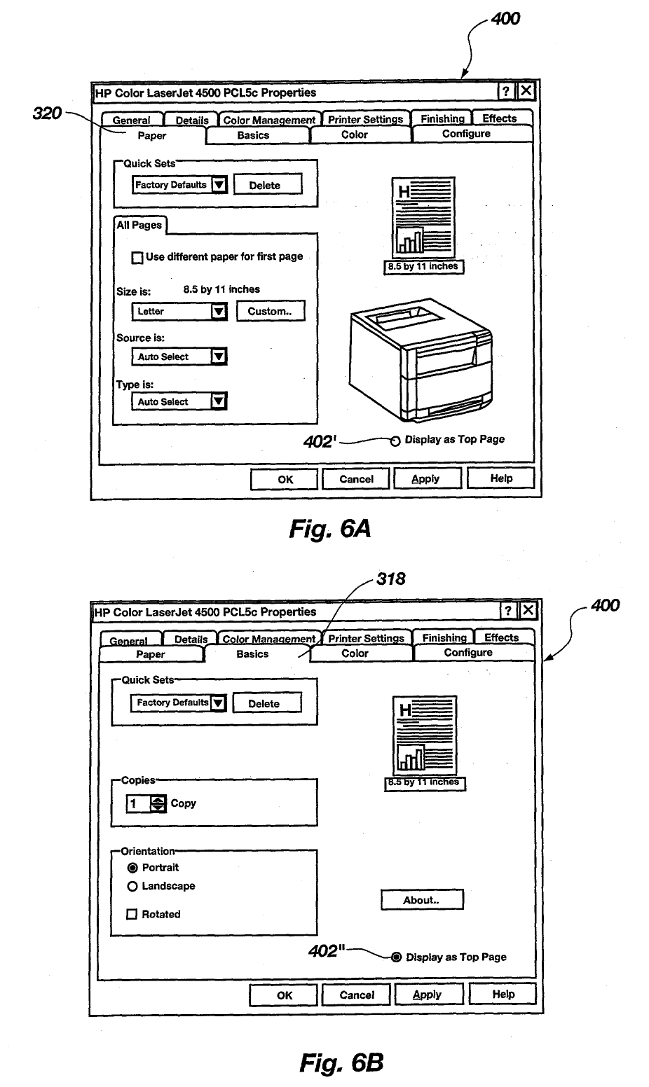

Drawing FIG. 5 illustrates the “at launch” condition of printer driver dialog box 400 in which “Paper” page 320 has been set as the top page of printer driver dialog box 400. As can be seen in drawing FIG. 5, selection element 402 has been selected on “Paper” page 320. In this condition, printer driver dialog box 400 will display “Paper” page 320 as the top page each time printer driver dialog box 400 is launched. Of course, the user may also navigate through the other pages of printer driver dialog box 400 in the conventional manner. Additionally, the selection element 402 may be present in any desired submenu for control of the first page displayed to eliminate scrolling through menus and submenus to get to the desired page to be displayed first. In this manner the first page for display may be tailored for each individual.

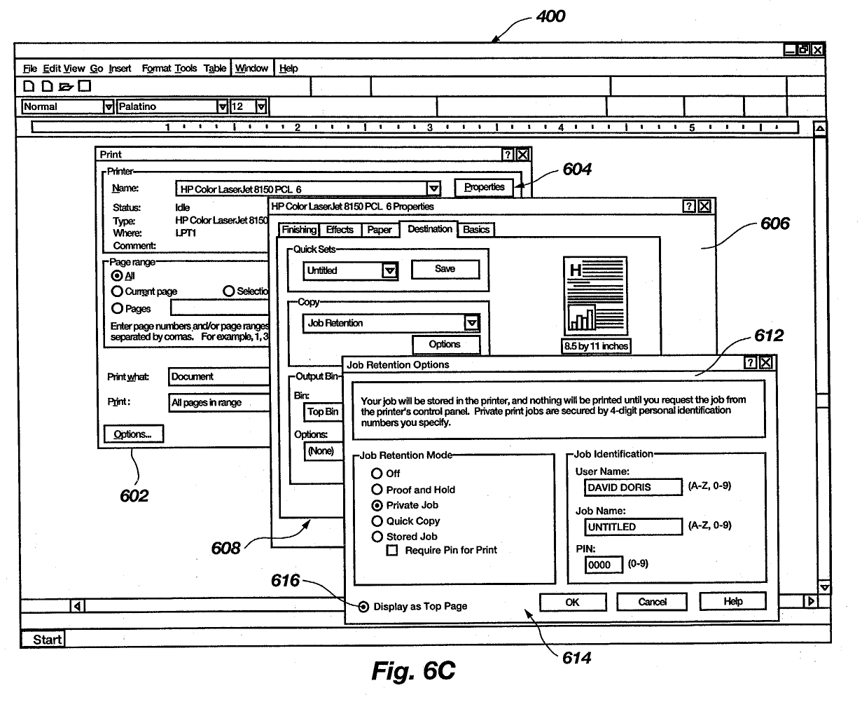

Drawing FIGS. 6A, 6B, and 6C illustrate printer driver dialog box 400 in which a different page has been designated as the top page. Because a page other than “Paper” page 320 has been selected, selection element 402 on that page has been unselected and is depicted as unselected selection element 402′. In drawing FIG. 6B, “Basics” page 318 has been designated as the top page by selection of selection element 402 on “Basics” page 318, which is illustrated in FIG. 6B as selected selection element 402″. As illustrated in drawing FIG. 6C, main page 602 is illustrated having properties box 604opening dialog box 606 having various properties 608 displayed thereon such as an Options box 610 which, in turn opens dialog box 612 having various job retention options listed as a submenu 614 which includes the job option 616 for the display of the dialog box 612 as the top page. In such manner, any page and only one page is designated as the top page at any time.

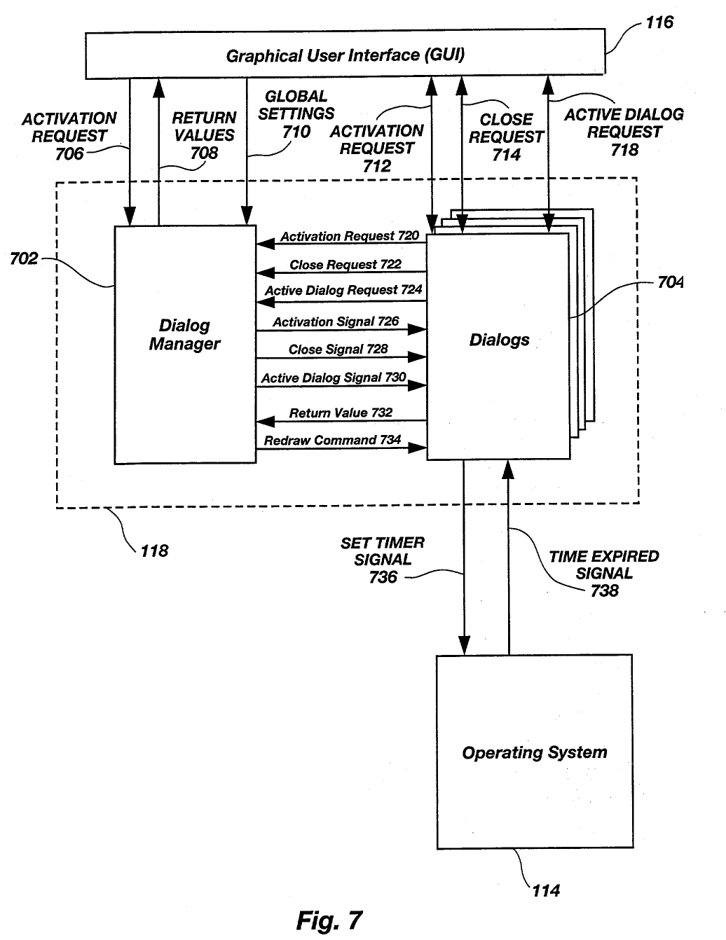

Illustrated in drawing FIG. 7 is a functional block diagram of one embodiment of the dialog box control system 118 of the present invention. One implementation of dialog box control system 118 is in a commonly available computer-based system having a graphical user interface and a pointing device. Control system 118 broadly includes a dialog manager 702 and a plurality of dialogs 704. Each dialog 704 is preferably a logical association of software code, such as one or more modules in a structured programming language, such as the C++ programming language. In some embodiments, dialogs 704 include one or more object classes in an in an object-oriented software language, such as C++ programming language. Each dialog 704 is constructed and arranged to manage the display of and user interactivity with an associated dialog box.

Dialog manager 702 controls dialogs 704 to render the dialog boxes and generate the appropriate system calls to the operating system 114 in accordance with a particular dialog launch configuration. This enables the dialog box control system 118 to cause only dialog box pages predetermined to be top pages, either through user designation or manufacturer default, to be displayed as the top page when the dialog box is launched. This also enables the dialog box control system 118 to provide the desired degree of user accessibility to the implementing computer-based system beyond the active dialog box in accordance with the dialog launch configuration with which each dialog box is launched.

As illustrated in drawing FIG. 2, the dialog box control system 118 interoperates with a currently executing operating system 114. The dialog box control system 118 is operatively interposed between the graphical user interface 116 and the operating system 114, controlling the generation of the system calls that are provided to the operating system 114.

It should be understood, however, that the embodiment of dialog box control system 118 illustrated in drawing FIG. 7 is implemented to enable the present invention to operate with a conventional operating system 114 and graphical user interface 116. In other embodiments, the present invention is an operating system incorporating the functionality of the present invention. In still another embodiment, a graphical user interface incorporating the functionality of the present invention is provided. Such embodiments of the present invention do not require the management of commands and function calls as in the described embodiments since the functionality would be incorporated and distributed within the operating system or graphical user interface rather than communicating with them. It follows that in other alternative embodiments, the functionality of the present invention may be distributed between a graphical user interface and an operating system.

A typical embodiment of dialog box control system 118 illustrated in drawing FIG. 7 will now be described in detail. Dialog box manager 702 receives global settings 710 from the graphical user interface 116. The exemplary global settings function call 710 may have the following exemplary parameters: (1) system access; (2) dialog box timeout; and (3) dialog box display options. Global settings 710 may include any parameter(s) deemed to be necessary or appropriate, including less than all the above parameters and/or additional parameters not mentioned here.

With regard to system access parameter(s), in one embodiment, the dialog box control system 118 controls the extent of a user's ability to effect changes in the system. It may sometimes be advantageous to limit a particular user's access to only certain predetermined parameters, settings, input fields, etc. Limiting a user's system access can help prevent the user from inadvertently or intentionally damaging the system through entry of erroneous and/or malicious control inputs. Such limitations may also make the dialog box easier for the user to use because the user need not concern himself or herself with the aspects of the system to which he or she does not have access.

With regard to the timeout value, in some embodiments of the present invention, the user can select or the application can predetermine a time duration during which the user must provide control inputs to an active dialog box. If there are no control inputs provided to the active dialog box during this time interval, the dialog control system 118 closes the active dialog box as described below. This timeout value may be provided as part of the global settings 710.

With regard to dialog box display options, as noted above, the present invention enables a user to designate the top page to be displayed upon launch of the dialog box. The dialog box display options include display parameters for dialog boxes that appear in the graphical user interface 116. These parameters include at least a specification of the top page of the dialog box, whether it is designated by the user or is the manufacturer's standard. Additionally, the dialog box display options may include one or more values representing a style and format in which the dialog boxes are to be displayed. Other display option, such as color options, may be provided to determine the colors in which the dialog boxes are rendered. For example, in one embodiment, there may be 4 variables, 2 for foreground color, and 2 for background color. The dialog display options may include any display parameters relating to the dialog boxes, as is deemed necessary or appropriate.

The return value 708 provided to the graphical user interface 116 by the dialog manager 702 indicates the manner in which the dialog box is to be closed due to the expiration of the timeout value. The dialog manager 702 can indicate to the graphical user interface 116 that the dialog box is to be selectively or non-selectively closed. This will cause the graphical user interface 116 to generate a close request 714 as described below.

When a dialog box is selected by the user to be launched, an activation request 706 or 712 is generated by the graphical user interface 116. If the user selects a dialog launch display element from the main menu in the typical embodiment described above, then the activation request 706 is generated by the graphical user interface 116 for the dialog box manager 702. This is because no dialog boxes are currently displayed and, therefore, none are active. As a result, no activation request 712 can be generated by the user selecting a launch display element displayed on such a dialog box. However, if the user selects a dialog box to be launched by selecting a launch display element located on a displayed dialog box, then the activation request 712 is provided to the dialog 704 associated with that dialog box as part of the control manipulations.

In accordance with one aspect of the present invention, the activation request 706, 712 is a function call having the following parameters: (1) dialog ID; (2) parent ID; and (3) assigned dialog modality. The dialog ID is an identifier of the dialog box represented by the selected launch display element. The parent dialog ID is an identifier that identifies the parent dialog box in accordance with the logical relationship dynamically established between the selected dialog box and the dialog box containing the selected launch display element.

As noted, the illustrative embodiment of the dialog box control system 118 shown in FIG. 2 is interposed between the graphical user interface 116 and the operating system 114. The dialog manager 702 makes the determination as to whether a dialog box is to be activated, closed or designated as the active dialog box. As a result, all commands provided to the dialogs 704 from the graphical user interface 116 relevant to the display control of the dialogs are not immediately processed by the dialogs themselves. Instead, in accordance with this aspect of the present invention, the dialogs 704 are constructed and arranged to provide these commands or function calls to the dialog manager 702 for processing.

These commands include the control manipulations, which include the activation request 712 and the close request 714. These are passed to the dialog manager 702 as the activation request 720 and the close request 722. Also passed to the dialog manager 702 is an active dialog request 724 generated in response to the receipt of the active dialog request 718 from graphical user interface 116.

The dialog manager 702 generates three signals received by the dialogs 704 representing the results of the functions and operations performed therein. These three signals are the activation signal 726, the close signal 728 and the active dialog signal 730.

The dialogs 704 may additionally generate a set timer signal 736 to the operating system 114 setting a timer value to the time out value provided by the graphical user interface as part of the global settings 710 described above. The operating system 114 generates a time expired signal 738 when the invoked timer reaches the indicated timeout value in the set timer signal 736. This causes the dialogs 704 to generate the return value 732 to the dialog manager 702. This return value identifies the manner (selectively or non-selectively) in which the dialog should be closed, as noted above.

The dialog manger 702 provides the dialogs 704 with a redraw command 734 when the display options have been changed. The redraw command 734 causes the receiving dialog 704 to render the associated dialog box on the graphical user interface 116 in accordance with such display options.

As one skilled in the relevant art would find apparent, other dialog box display and control operations may be provided by the dialog box manager 702. For example, specific dialog boxes can be made active under certain conditions, certain dialog boxes can be activated, etc. Furthermore, as one skilled in the relevant art would find apparent, display elements other than dialog boxes may also be controlled in accordance with the present invention. Such display elements, such as menus, icons and the like are located at other locations on the graphical user interface and could be managed in a similar fashion. In such embodiments, the dialog manger 702 would receive the appropriate function call from the graphical user interface 116 indicating that the user has selected such an icon or menu item.

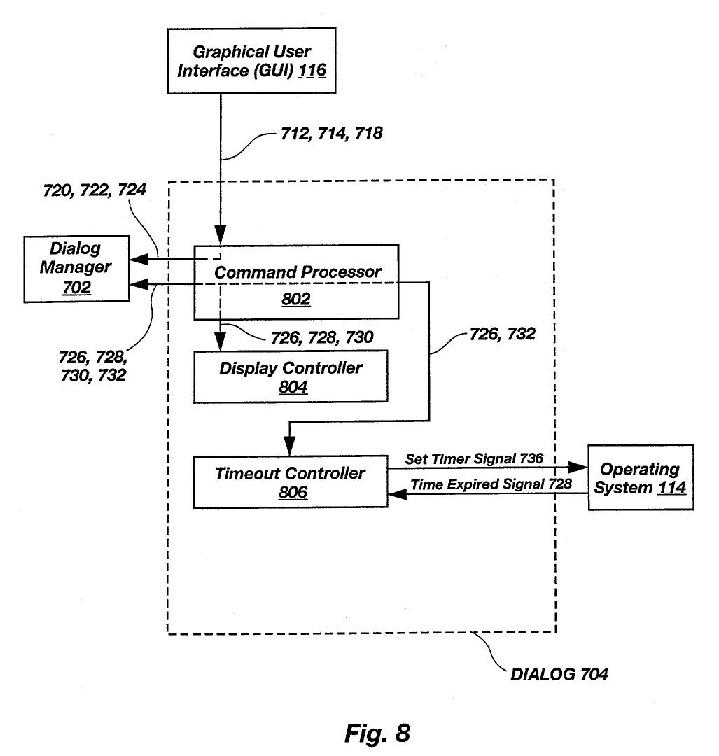

Drawing FIG. 8 illustrates a functional block diagram of one embodiment of the dialogs 704 of the present invention. The illustrative dialog 704 includes a command processor 802, a display controller 804 and, in some embodiments, a timeout controller 806. The display controller 804 performs well-known operations associated with the display and control of the associated dialog box on the graphical user interface 116. The structure, functions and operations of the display controller 804 are considered to be well known in the art and are, therefore, not described further herein.

The command processor 802 routes function calls and commands in accordance with one embodiment of the present invention. In particular, the command processor 802 receives dialog box control manipulations 712, 714, 718 from the graphical user interface 116, as described above. The dialog box control manipulations include the dialog box activation request 712, dialog box close request 714 and active dialog box request 718. The command processor 802 routes these function calls to the dialog manager 702 to enable the dialog manager 702 to determine which function calls should be provided to the dialogs 704 to implement a desired dialog launch function. Once this determination is made, the dialog manager 702 forwards one or more of signals 726, 728, 730 to the appropriate dialogs 704. The dialogs 704 then display and control their respective dialog boxes in response to signals 726, 728, 730, managing the display and interactivity of the dialog boxes in a known manner.

In one embodiment, the dialogs 704 also include a timeout controller 806. The timeout controller 806 performs the timeout related functions described above. The timeout controller 806 receives the externally provided timeout value from the dialog manager 702 via the command processor 802, as noted above. The timeout controller 806 generates the timer signal 736 and receives the time expired signal 728 from the operating system 114. The timeout controller 806 generates the return value 732 to the dialog manager 702 via the command processor 802 when the timeout period for an active dialog box has expired. The dialog manager 702 then closes the dialog box in accordance with the present invention.

Alternative embodiments to the dialogs 704 may be implemented in the present invention. For example, in one embodiment, the dialog manager 702 includes the command processor 802 described above. In this or alternative embodiments, the timeout controller 806 is either included in the dialog manager 702 as well or is not implemented in the control system 118. The dialogs 704, then, would only include the conventional display controller 804. As such, the dialog manager 702 would be interposed between the conventional dialog controller 704 and both the operating system 114 and the graphical user interface 116. Such embodiments of the present invention may be more appropriately implemented in other embodiments, such as when the present invention is implemented in the graphical user interface 116 and/or operating system 114.

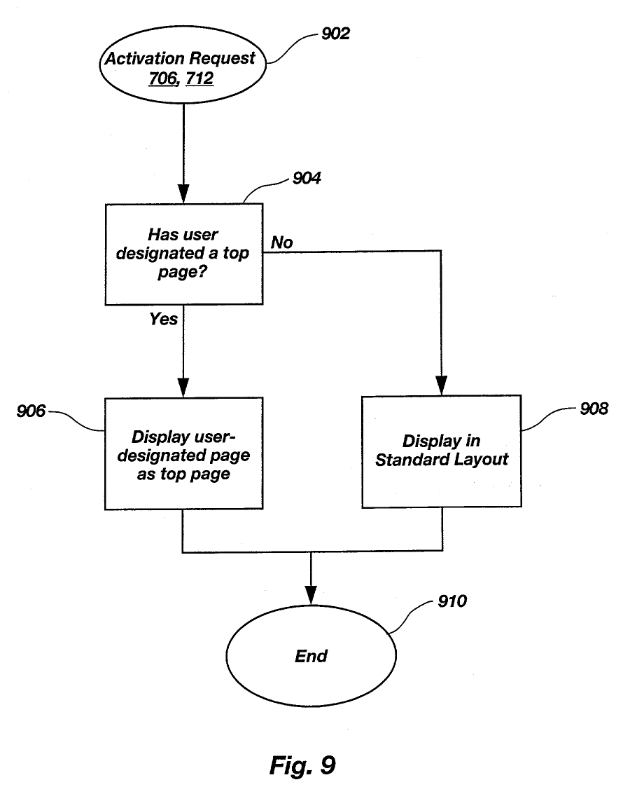

Referring now to drawing FIG. 9, the method according to the present is illustrated. When an activation request 706, 712 is generated, as shown in box 902, dialog box control system 118 first determines whether any page of the subject dialog box has been designated by the user to be displayed as the top page of the dialog box, as shown in box 904. If no page has been user-designated as the top page, the dialog box control system causes the dialog box to be displayed in standard format, as shown in box 908. If a page of the dialog box has been designated by the user to be displayed as the top page, the dialog box control system causes the user-designated page to be displayed as the top page, as shown in box 906. The display of the dialog box in either standard format or with the user-designated page as the top page concludes the method, as shown at box 910.

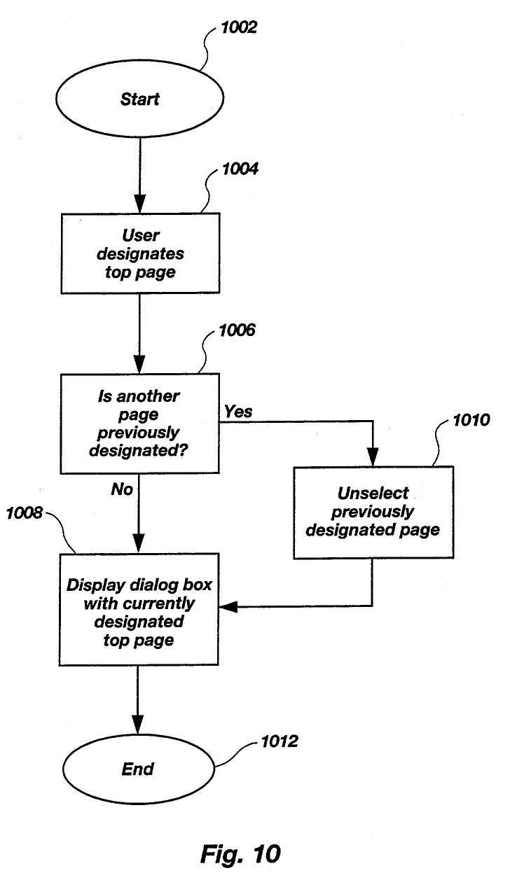

Illustrated in drawing FIG. 10 is that portion of the method according to the present invention in which dialog box control system 118 processes a user designation of a page of the dialog box as the top page. When a user designates a page of the dialog box as the top page by selecting selection element 402 on the subject page, the designation is received and processed by dialog box control system 118, as show in box 1004. Dialog box control system 118 determines whether any other page of the dialog box has been previously designated as the top page, as shown in box 1006. As shown at box 1008, if no other page of the dialog box has been previously designated as the top page, dialog box control system 118 proceeds to cause the dialog box to be displayed with the page designated at box 1004 as the top page. As shown at box 1010, if a different page of the dialog box has been previously designated as the top page, dialog box control system 118 causes the previously designated page to be unselected and proceeds to display the dialog box with the page designated at box 1004 as the top page, as shown at box 1008.

Having thus described certain preferred embodiments of the present invention, it is to be understood that the invention is not to be limited by particular details set forth in the above description, as many apparent variations thereof are possible without departing from the spirit or scope thereof.

What is claimed is:

1. In a graphical user interface in a computer system having an operating system, a method for managing the display of dialog boxes in response to an activation request to open a selected dialog box comprising a plurality of pages, the method comprising:
enabling a user to designate one of the plurality of pages of the selected dialog box to be displayed as the top page of the selected dialog box when the selected dialog box is launched; and
displaying the selected dialog box with the user-designated page as the top page when the selected dialog box is launched.

2. The method according to claim 1, wherein enabling a user to designate one of the plurality of pages of the selected dialog box to be displayed as the top page of the selected dialog box comprises:
providing a selection element on each of the plurality of pages of the selected dialog box; and
enabling the user to designate one of the plurality of pages as the top page by selecting the selection element on the page to be so designated.

3. The method according to claim 1, wherein when the user has previously designated a first page as the top page and the later designates a second page as the top page, the first page is undesignated automatically.

4. The method according to claim 1, wherein the activation request is generated through a selection of a dialog launch display element.

5. The method according to claim 4, wherein the selection of the dialog launch display element is affected with a pointing device.

6. The method according to claim 1, wherein the activation request is generated in response to the occurrence of an event in a process monitored by the operating system.

7. The method according to claim 1, wherein if no page has been user-designated to be displayed as the top page when the selected dialog box is launched, and the standard layout of the selected dialog box is displayed.

8. A computer program product for use with a computer system having an operating system, the computer program product comprising a computer usable medium having embodied therein a computer readable program code method for managing a graphical user interface in the computer system in response to receipt of an activation request to open a selected dialog box comprising a plurality of pages, the computer readable program code method comprising:
enabling a user to designate one of the plurality of pages of the selected dialog box to be displayed as the top page of the selected dialog box when the selected dialog box is launched; and
displaying the selected dialog box with the user designated page as the top page when the selected dialog box is launched.

9. The computer program product of claim 8, wherein enabling a user to designate one of the plurality of pages of the selected dialog box to be displayed as the top page of the selected dialog box comprises:
providing a selection element on each of the plurality of pages of the selected dialog box; and
enabling the user to designate one of the plurality of pages as the top page by selecting the selection element on the page to be so designated.

10. The computer program product of claim 8, wherein the activation request is generated through a selection of a dialog launch display element.

11. The computer program product of claim 10, wherein the selection of the dialog launch display element is affected with a pointing device.

12. The computer program product of claim 8, wherein the activation request is generated in response to the occurrence of an event in a process monitored by the operating system.

13. An operating system for use in a computer system comprising:
a graphical user interface configured to generate at least one dialog box control request in response to a user input provided on a display device;
a plurality of dialogs, each for controlling a display of and interactivity with an associated dialog box in response to a dialog box control request; and
a dialog box control system constructed and arranged to display a user-designated page of a selected dialog box as the top page of the selected dialog box when the selected dialog box is launched for controlling generation of one or more system calls within the operating system, and for controlling the providing of the dialog box control request generated by the graphical user interface to the plurality of dialogs.

14. The operating system of claim 13, wherein the user is enabled to designate the user-designated page of the selected dialog box by selecting a selection element provided on the page to be so designated.

15. The operating system of claim 13, wherein the user input provided on the display device comprises a selection of a dialog launch display element.

16. A computer system comprising:
an operating system responsive to one or more system calls, each causing said operating system to process user inputs in a predetermined manner;
a graphical user interface configured to generate one or more dialog box control requests in response to user inputs provided on the graphical user interface;
a plurality of dialogs, each constructed and arranged to control display of and interactivity with an associated dialog box open on the graphical user interface in response to one or more of the dialog box control requests; and
a dialog box control system operatively interposed between the graphical user interface and the operating system constructed and arranged to display a user-designated page of a selected dialog box as the top page of the selected dialog box when the selected dialog box is launched to control generation of one or more system calls within the operating system, and to control providing the dialog box control request generated by the graphical user interface to the plurality of dialogs.

17. The computer system of claim 16, wherein each of the plurality of dialogs comprises:
a display controller constructed and arranged to control display of and interactivity with the associated dialog box on the graphical user interface; and
a command processor constructed and arranged to direct dialog box control requests received from the graphical user interface to the dialog box control system and to forward dialog box requests received from the dialog box control system to the display controller,
wherein each display controller controls the associated dialog box in accordance with the received dialog box requests.

18. In a computer-based system having an operating system and a graphical user interface, an apparatus for managing the graphical user interface display and interactivity with respect to a selected one of a plurality of dialog boxes to be opened on the graphical user interface, for each of said plurality of dialog boxes the apparatus displaying a user-designated page of the dialog box as the top page of the dialog box when the dialog box is launched.

19. The apparatus of claim 18, wherein a user is enabled to designate the page to be displayed as the top page of the dialog box by selecting a selection element provided on the page to be so designated.

20. A dialog box control system for use in a computer system, the dialog box control system being constructed and arranged to cause display of a user-designated page of a dialog box having a plurality of pages, each one of the plurality of pages having a selection element provided thereon, as the top page of the dialog box when the dialog box is launched.

21. The dialog box control system of claim 20, wherein a user is enabled to designate one of the plurality of pages of the dialog box as the top page by selecting the selection element on the page to be so designated.
